(19) United States
(12) Patent Application Publication
(10) Pub. No.: US 2009/0112716 A1
(43) Pub. Date: Apr. 30, 2009

(54) MARKETING SERVICE METHOD EMPLOYING PRODUCT SAMPLE

(76) Inventor: Eui Shik Um, SEOUL (KR)

Correspondence Address: IPLA P.A., 3580 WILSHIRE BLVD., 17TH FLOOR, LOS ANGELES, CA, 90010, US

(21) Appl. No.: 12/102,755

(22) Filed: Apr. 14, 2008

(30) Foreign Application Priority Data
Oct. 29, 2007 (KR) 10-2007-0109099

(51) Int. Cl. G06Q 30/00

(52) U.S. Cl. 705/14

(57) ABSTRACT

Provided is a marketing service method where manufacturers fabricate samples and exhibit the fabricated samples through a specific exhibition hall before producing and supplying products to consumers, allow the consumers to test the samples, and produce the products by reflecting demonstration effects or opinions of consumers. The marketing service method includes a database construction step of receiving a sample and sample information from a manufacturer and constructing a DB using the sample and the sample information, a step of checking whether member information, corresponding to the sample and the sample information constructed in the DB, exists, providing the sample and the sample information to a pertinent member, and requesting the member to create marketing information with respect to the sample and the sample information, and an information providing step of receiving the marketing information from the member and supplying the received marketing information to a pertinent sample supplier.

### CROSS REFERENCE

This application claims foreign priority under Paris Convention to Korean Patent Application No. 10-2007-0109099, filed Oct. 29, 2007 with the Korean Intellectual Property Office.

### BACKGROUND ART

The present invention relates to a marketing service method employing product samples, and more particularly, to a marketing service method employing product samples, in which manufacturers that produce and supply specific products fabricate samples and exhibit the fabricated samples through a specific exhibition hall, before producing and supplying the products to consumers, allow the consumers who will purchase the products to test the samples, and produce the products by reflecting demonstration effects or opinions of consumers who have tested the samples.

In most manufacturers that fabricate specific products, monitors who belong to the manufacturers visit consumers and seek the consumers' advice on the products through a survey before the products are fabricated by the manufacturers. The manufacturers set up marketing strategies based on the consumer survey.

With the rapid development of a communication network, a lot of manufacturers create their e-mail accounts or web sites instead of the above old-fashioned survey method. Thus, people who receive e-mails regarding sample products or who visit the web sites on which information about the sample products is posted can fill out the survey of the sample information. However, the above method employing e-mails and web sites is problematic in that the response rate is too low because users are not actively involved in the survey.

Further, manufacturers want many people to test and evaluate samples of products that will be mass-produced by exhibiting them through exhibition halls. To this end, the manufacturers must check the exhibition schedules, etc. of the exhibition halls. However, there are problems in that the manufacturers are very difficult to check the schedules one by one and are likely to miss an opportunity, making impossible to exhibit samples at an appropriate time.

Further, manufacturers require high mass-production cost in mass-producing specific products and, therefore, must frequently apply for fund to a country, local governments, financial institutions and so on. Thus, the manufacturers do not know which fund or when the fund will be supplied or which fund has good conditions if they do not take them hard.

Accordingly, a problem arises because the most appropriate fund cannot be supplied to the manufacturers.

### SUMMARY OF THE INVENTION

Accordingly, the present invention has been made in view of the above problems occurring in the prior art, and an object of the present invention is to provide a marketing service method employing product samples, in which manufacturers that produce and supply specific products fabricate samples and exhibit the fabricated samples through a specific exhibition hall, before producing and supplying the products to consumers, allow consumers who will purchase the products to test the samples, and produce the products by reflecting demonstration effects or opinions of consumers who have tested the samples. Another object of the present invention is to provide a marketing service method employing product samples, in which a sample for exhibition is previously received from a manufacturer and then exhibited when there is an exhibition schedule that is most suitable for the sample, and the manufacturer's administrator is informed of the exhibition schedule.

To achieve the above objects, a method of providing a marketing service employing samples according to an aspect of the present invention includes (1) a database (DB) construction step of receiving a sample and sample information from a manufacturer that produces specific products and constructing a DB using the sample and the sample information, (2) a step of checking whether member information, corresponding to the sample and the sample information constructed in the DB, exists, providing the sample and the sample information to a pertinent member, and requesting the member to create marketing information with respect to the sample and the sample information, and (3) an information providing step of receiving the marketing information from the member and supplying the received marketing information to a pertinent sample supplier. The marketing service method may further include (4) an exhibition service step of, if the sample is received from the manufacturer, extracting information about an exhibition hall based on the sample information, requesting the sample to be exhibited at a corresponding exhibition hall, and delivering the sample to the exhibition hall according to an exhibition period.

The marketing service method may further include a member management step of, if a specific user subscribes as a member, determining whether the user is a free member or a paid member and differently setting the number of requesting a product test and marketability evaluation according to the determination result. The request step comprises the step of checking the number of requests when requesting a specific user to perform a product test and marketability evaluation, and allocating the requests to other member when the number of requests is exceeded.

The marketing service method may further include a service step of receiving product information from the manufacturer, displaying the received product information, and providing demonstration information so that the product is sold. The service step may include the step of providing image information of the product, which is received from the manufacturer, to a user on a per technology or company basis so that the user can search the product according to classified contents.

Further, a product test and marketability evaluation method requested in the request step is performed using any one of product use notes, questionnaire fill-out, and bulletin writings.

Further, in the information providing step, any one of market research information, product analysis data information and consumer response data corresponding to the product information provided from the manufacturer is provided.

Accordingly, the present invention can provide consumers with rooms for evaluation and advice on product test and marketability, suppliers with rooms for consumer recognition survey and product review according to a manufacturer's request, and manufacturers with rooms for achieving a maximum of efficiency at the least expense with respect to pre- and post-marketing after the production of products.

Further, according to the present invention, a sample for exhibition is previously supplied from a manufacturer and then exhibited at the most appropriate time when there is an exhibition schedule, and the manufacturer's administrator is informed of the exhibition schedule. Accordingly, there is an advantage in that a manufacturer's administrator does not need to make a separate effort to exhibit its product sample.

### BRIEF DESCRIPTION OF DRAWINGS

Further objects and advantages of the invention can be more fully understood from the following detailed description taken in conjunction with the accompanying drawings in which:

FIG. 1 illustrates the configuration of a marketing service system employing product samples according to the present invention;

FIG. 2 illustrates the construction of a sample/management service server applied to the configuration of FIG. 1; and

FIGS. 3 to 5 are flowcharts illustrating a marketing service method employing product samples according to the present invention.

### EXPLANATION ON REFERENCE NUMERALS OF MAIN ELEMENTS IN THE DRAWINGS

100: user terminal 200: sample supplier terminal
300: data communication network
400: sample/management service server
500: delivery management server
600: exhibition service server

### DETAILED DESCRIPTION OF THE INVENTION

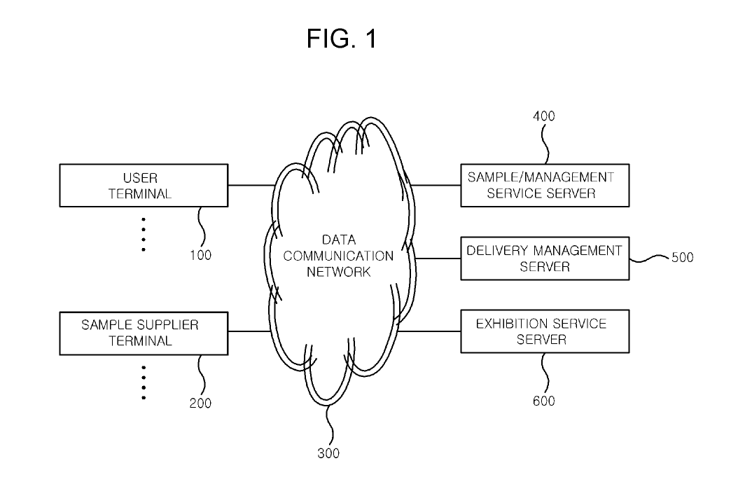

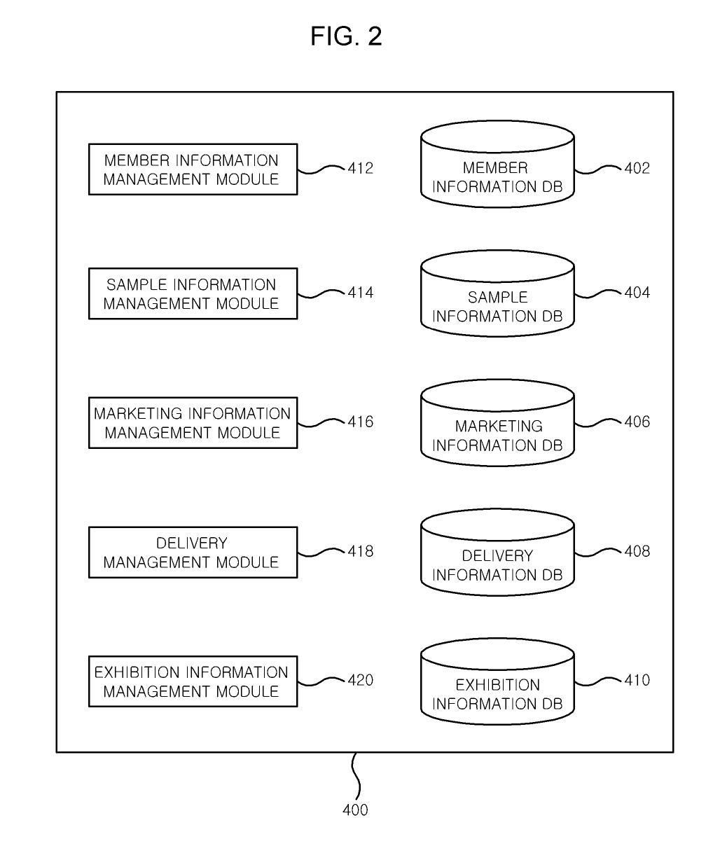

The present invention will now be described in detail in connection with specific embodiments with reference to the accompanying drawings. Hereinafter, a marketing service system employing product samples is described below with reference to FIGS. 1 and 2.

The marketing service system according to the present invention includes, as shown in FIG. 1, a user terminal 100, a sample supplier terminal 200, a data communication network 300, a sample/management service server 400, a delivery management server 500, and an exhibition service server 600.

The user terminal 100 can include a personal computer (PC) having a web browser thereon or a mobile communication terminal having a WAP browser thereon. A user can gain access to the marketing service system on-line and search a sample of a specific product, which is provided on-line, or samples of products that are sold or exhibited. The user can also create marketing information, including market research, product analysis data, consumer response data, etc., based on information about samples, which are directly delivered in response to a request from the sample/management service server 400, or samples provided on-line, and upload the information to the sample/management service server 400.

The sample supplier terminal 200 is installed at a manufacturer that provides the sample/management service server 400 with a sample of a specific product. The sample supplier terminal 200 provides the sample/management service server 400 with sample information on-line, for example, information including still images or motion images through which samples can be viewed on-line, delivery information when a sample is delivered to a specific place, etc., and is supplied with marketing information, including product use notes (consumer's response data), marketability research, product analysis data, etc., from the sample/management service server 400.

The data communication network 300 includes wired/wireless communication networks such as an Internet or WAP, and enables many and unspecified persons to gain access to the sample/management service server 400 on-line and then receive information from the sample/management service server 400.

The sample/management service server 400 receives samples and sample information from a specific manufacturer and provides them on-line or through an off-line shop. The sample/management service server 400 also provides the samples and/or the sample information to users who are registered as members, so that the users can create marketing information, including market research information, product analysis data, consumer response data, etc., and upload the created marketing information to the sample/management service server 400.

The sample/management service server 400 includes, as shown in FIG. 2, a member information database (DB) 402 in which user ID information is matched to profile information, which is entered when a specific user is registered as a member, and stored together with the user's member grade information, a sample information DB 404 in which sample information and request information from a manufacturer are stored, a marketing information DB 406 in which marketing information, comprised of market research information, product analysis data, consumer response data, etc., which are written by users who are registered as members, are matched to sample ID information and stored, a delivery information DB 408 in which information about the delivery route of the sample is matched to the sample ID information and stored, an exhibition information DB 410 in which the sample's exhibition information is matched to the sample ID information and stored, a member information management module 412 in which a user is guided to select a paid or free member when registering as a member, user ID information (ID, password) is issued and provided to a user when the user executes a member subscription routine, and the user's profile information is matched to the user's ID information and stored in the member information DB 402, a sample information management module 414 which receives sample information and request information from a manufacturer and store them in the sample information DB 404, and also provides the sample information and request information to the marketing information management module 416 so that marketing information can be created based on the sample information and request information, a marketing information management module 416 which receives the sample information and the request information from the sample information management module 414, if it is determined that the request information is an exhibition request, provides the sample information to the exhibition information management module 420, and if the request information is marketing information comprised of market research, product analysis data, consumer response data, etc., reads member information corresponding to the request information, of members registered with the member information DB 402, and provides the request information to the exhibition information management module 420 together with the sample information, a delivery management module 418 which delivers a sample to a specific place in response to a request from the marketing information management module 416 and stores and manages information, occurring during the delivery process, in the delivery information DB 408, and an exhibition information management module 420 which exhibits the delivered sample to be exhibited at a specific exhibition hall in response to a request from the marketing information management module 416.

The member information management module 412 manages users so that they can be identified as paid or free members and provides differentiated information to the users.

The marketing information management module 416 checks whether there exist marketing reports to be sent to a pertinent member when selecting the member and determines whether the number of reports allocated to a pertinent member has exceeded a set number.

The delivery management server 500 delivers a sample to a specific place or other places in response to a manufacturer's request on-line or off-line or the sample/management service server 400's request on-line or off-line, and provides the delivery information to a user or a user or administrator of the sample/management service server 400.

The exhibition service server 600 notices a sample exhibition place and an exhibition schedule, decides a sample exhibition schedule and exhibition place in response to a request from the sample/management service server 400, and exhibits the delivered sample.

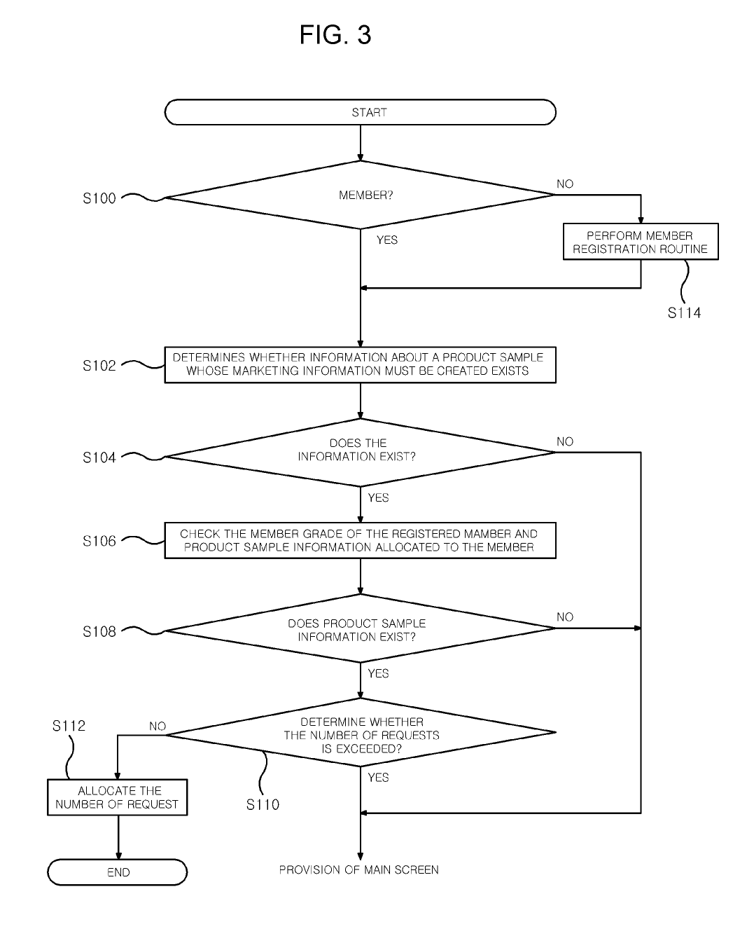

An operation method of the marketing service system constructed as above is described below with reference to FIGS. 3 to 5.

If a specific user accesses the sample/management service server 400 on-line using the user terminal 100 or the sample supplier terminal 200, the sample/management service server 400 determines whether the user is a registered member based on ID information input by the user (S100).

If, as a result of the determination in step S100, the user is not a registered member, the sample/management service server 400 outputs a member subscription guidance message through the member information management module 412 so that the user can become a member (S114).

If, as a result of the determination in step S100, the user is a registered member, the sample/management service server 400 checks whether the registered member is a paid or free member, a user who creates marketing information, or a user (administrator) manufacturer that provides a sample based on the member ID information.

If, as a result of the check, the registered member is a user who creates marketing information, the sample/management service server 400 determines whether information about a product sample whose marketing information must be created exists (S102) and determines whether the information about the product sample exists (S104).

If, as a result of the determination in step S104, the information about the product sample exists, the sample/management service server 400 checks the member grade of the registered member and product sample information allocated to the member (S106). The sample/management service server 400 then determines whether the product sample information allocated to the member exists (S108). If, as a result of the determination in step S108, the product sample information allocated to the member exists, the sample/management service server 400 determines the number of requests has been exceeded (S110). If, as a result of the determination in step S110, the number of requests has not been exceeded, the sample/management service server 400 allocates the number of requests to the member so that the member can create marketing information (S112).

If, as a result of the determination in step S110, the request number has exceeded, the sample/management service server 400 provides the member with a screen on which a main screen for providing general information is displayed.

The above request method may be implemented in various ways, such as employing e-mail or a text message, as well as a request method when a pertinent web site is accessed as described above.

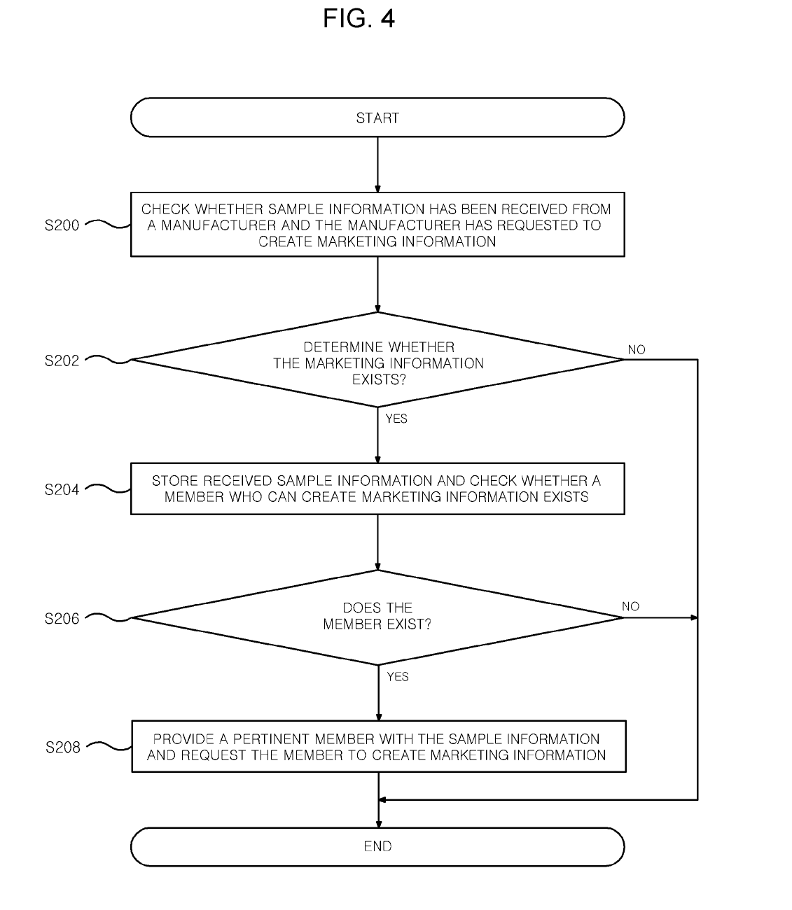

In other words, as shown in FIG. 4, the sample/management service server 400 checks whether sample information has been received from a manufacturer and the manufacturer has requested to create marketing information (S200). The sample/management service server 400 then determines whether the marketing information exists (S202).

If, as a result of the determination in step S202, the marketing information exists, the sample/management service server 400 stores the sample information received from the manufacturer and checks whether a member who can create marketing information exists (S204). The sample/management service server 400 then determines whether created marketing information exists (S206). If, as a result of the determination in step S206, created marketing information exists, the sample/management service server 400 provides a pertinent member with the sample information and requests the member to create marketing information (S208).

In this case, the sample information may be provided so that it can be confirmed on-line such as an Internet, if appropriate. Alternatively, the sample may be directly delivered through a delivery company.

Meanwhile, after requesting the registered member to create the marketing information as described above, the sample/management service server 400 begins checking an upload period of the sample from which the creation of the marketing information has been requested.

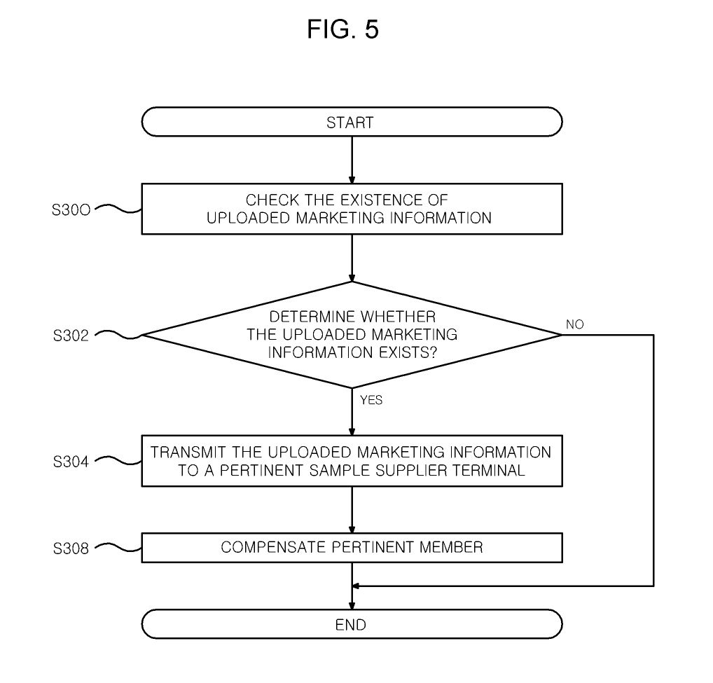

In other words, as shown in FIG. 5, the sample/management service server 400 checks the existence of uploaded marketing information (S300) and determines whether the uploaded marketing information exists (S302). If, as a result of the determination in step S302, the uploaded marketing information exists, the sample/management service server 400 transmits the uploaded marketing information to a pertinent sample supplier terminal 200 so that a pertinent member can be offered compensation (S304).

Meanwhile, when a manufacturer makes a request for the sample received from the sample supplier or appropriate exhibition information about the sample exists, the sample/management service server 400 provides the sample or the exhibition information about the sample to the manufacturer so that it can be displayed through an exhibition hall. At this time, the sample/management service server 400 can decide a place where a product will be placed and designs a booth while exchanging exhibition information with the exhibition management server 600, and exhibits the sample.

Further, the sample/management service server 400 can provide a member information DB, received from the sample supplier, to the manufacturer, check whether fund from government institutes is supplied to the manufacturer, and provide information about the supply of the fund to a pertinent sample supplier, in addition to the above services.

Accordingly, the present invention can provide consumers with rooms for evaluation and advice on product test and marketability, suppliers with rooms for consumer recognition survey and product review according to a manufacturer's request, and manufacturers with rooms for achieving a maximum of efficiency at the least expense with respect to pre- and post-marketing after the production of products.

Further, according to the present invention, a sample for exhibition is previously supplied from a manufacturer and then exhibited at the most appropriate time when there is an exhibition schedule, and the manufacturer's administrator is informed of the exhibition schedule. Accordingly, there is an advantage in that a manufacturer's administrator does not need to make a separate effort to exhibit its product sample. Although the specific embodiments of the present invention have been disclosed for illustrative purposes, those skilled in the art will appreciate that various modifications, additions and substitutions are possible, without departing from the scope and spirit of the invention as disclosed in the accompanying claims.

1. A marketing service method employing product samples, comprising:
(1) a database (DB) construction step of receiving a sample and sample information from a manufacturer that produces specific products and constructing a DB using the sample and the sample information;
(2) a step of checking whether member information, corresponding to the sample and the sample information constructed in the DB, exists, providing the sample and the sample information to a pertinent member, and requesting the member to create marketing information with respect to the sample and the sample information; and
(3) an information providing step of receiving the marketing information from the member and supplying the received marketing information to a pertinent sample supplier.

2. The marketing service method of claim 1, further comprising (4) an exhibition service step of, if the sample is received from the manufacturer, extracting information about an exhibition hall based on the sample information, requesting the sample to be exhibited at a corresponding exhibition hall, and delivering the sample to the exhibition hall according to an exhibition period.

3. The marketing service method of claim 1, further comprising a member management step of, if a specific user subscribes as a member, determining whether the user is a free member or a paid member and differently setting the number of requesting a product test and marketability evaluation according to the determination result,
wherein the request step comprises the step of checking the number of requests when requesting a specific user to perform a product test and marketability evaluation, and allocating the requests to other member when the number of requests is exceeded.

4. The marketing service method of claim 1, further comprising a service step of receiving product information from the manufacturer, displaying the received product information, and providing demonstration information so that the product is sold.

5. The marketing service method of claim 4, wherein the service step comprises the step of providing image information of the product, which is received from the manufacturer, to a user on a per technology or company basis so that the user can search the product according to classified contents.

6. The marketing service method of claim 1, wherein a product test and marketability evaluation method requested in the request step is performed using any one of product use notes, questionnaire fill-out, and bulletin writings.

7. The marketing service method of claim 1, wherein in the information providing step, any one of market research information, product analysis data information and consumer response data corresponding to the product information provided from the manufacturer is provided.
